(19) United States
(12) Patent Application Publication
(10) Pub. No.: US 2026/0209596 A1
(43) Pub. Date: Jul. 23, 2026

(54) ENCAPSULATED NANOPARTICLE FILM COMPOSITIONS AND METHODS

(71) Applicant: UbiQD, Inc., Los Alamos, NM (US)

(72) Inventors: Karthik Ramasamy, White Rock, NM (US); Hunter McDaniel, Los Alamos, NM (US)

(21) Appl. No.: 19/140,809

(22) PCT Filed: Dec. 22, 2023
(86) PCT No.: PCT/US2023/085689

§ 371 Date: Jun. 18, 2025

Related U.S. Application Data
(60) Provisional application No. 63/477,615, filed on Dec. 29, 2022.
(60) Provisional application No. 63/479,077, filed on Jan. 9, 2023.

(51) Int. Cl. C09K 11/62; C09K 11/02

(52) U.S. Cl. CPC C09K 11/621; C09K 11/025

(57) ABSTRACT

The present invention is directed to nanoparticle formulations having improved photostability provided by the addition of aluminum atoms in various ways including them into the nanoparticle core-shell structure and/or by including a metal oxide layer such as an aluminum oxide layer over the nanoparticle core-shell structure.

### CROSS-REFERENCE TO RELATED APPLICATIONS

This application claims priority to U.S. provisional applications 63/477,615, filed Dec. 29, 2022, and 63/479,077, filed Jan. 9, 2023, the contents of which are incorporated herein by reference in their entireties.

### FIELD OF THE DISCLOSURE

The present invention is directed to nanoparticle formulations having improved photostability. Such improved photostability can be provided by addition of aluminum atoms to the nanoparticle core-shell structure. Such improved photostability can also be provided by including a metal oxide layer such as an aluminum oxide layer over the nanoparticle core-shell structure. Such nanoparticles can be photoluminescent nanoparticle materials such as quantum dots (QDs).

### BACKGROUND OF THE DISCLOSURE

Semiconductor quantum dots have attracted significant interest in various applications because of their excellent optical and electronic properties. Yet, photostability of such quantum dots has always posed application challenges. Many applications require suitable lifetimes of the quantum yields or photoluminescence for widespread usage without a constant need for replacement.

### SUMMARY OF THE DISCLOSURE

In one aspect, a composition is provided including a plurality of fluorophore particles, each particle comprised of at least one semiconductor core and at least one semiconductor shell at least partially surrounding the core, wherein the resultant core-shell structure of the particles further includes at least one aluminum atom, the composition characterized as having increased photostability in comparison to an aluminum-absent core-shell structure.

In a further aspect, the surface of the fluorophore particle shell can be further capped with silane ligand and in a still further aspect the fluorophore particles can be subsequently at least partially overcoated upon the shell with a metal oxide layer.

In another aspect, an optical medium is provided including a polymer matrix and a plurality of fluorophore particles, each particle comprised of at least one semiconductor core and at least one semiconductor shell at least partially surrounding the core, wherein the resultant core-shell of the fluorophore particles further includes at least one metal dopant.

In a further aspect of the optical medium, the surface of the fluorophore particle shell can be further capped with silane ligands, and in a still further aspect the fluorophore particles can be subsequently at least partially overcoated upon the shell with a metal oxide layer.

### BRIEF DESCRIPTION OF THE DRAWINGS

FIG. 1 shows a schematic view of the synthesis of CuInS₂/ZnS:Al, CuInS₂/ZnS:Al/Al₂O₃ and CuInS₂/ZnS:Al in Al₂O₃ matrix by colloidal, chemical vapor growth or spray pyrolysis methods.

FIG. 2 is a graph showing the photostability of CuInS₂/ZnS and CuInS₂/ZnS:Al laminated films, such films illuminated using 400 nm light at 50° C.

FIG. 3 is a graph showing photostability of CuInS₂/ZnS and CuInS₂/ZnS:Al/Al₂O₃ extruded films in ethylene vinylalcohol (EVOH) such films illuminated using 400 nm light at 50° C.

FIG. 4 is a graph showing photostability of CuInS₂/ZnS and CuInS₂/ZnS:Al/Al₂O₃ extruded films in ethylene vinylacetate (EVA) sandwiched between ethylene vinylalcohol (EVOH) such films illuminated using 400 nm light at 50° C.

FIG. 5 shows transmission electron microscope images of CuInS₂/ZnS:Al/Al₂O₃ quantum dots (QDs).

FIG. 6 shows transmission electron microscope images of CuInS₂/ZnS:Al QDs in Al₂O₃ matrix by spray pyrolysis.

FIG. 7 shows pictures of CuInS₂/ZnS, CuInS₂/ZnS:Al/Al₂O₃ and CuInS₂/ZnS:Al QDs in Al₂O₃ matrix powders in ambient and UV-light.

FIG. 8 shows pictures of CuInS₂/ZnS, CuInS₂/ZnS:Al/Al₂O₃ and CuInS₂/ZnS:Al QDs in Al₂O₃ matrix in concentrated nitric acid (HNO₃) under ambient and UV-light at (a) 5 min, (b) 15 min, (c) 30 min, (d) 60 min, (e) 90 min and (f) 120 min demonstrating chemical stability.

FIG. 9 shows infrared spectra of CuInS₂/ZnS:Al/Al₂O₃ quantum dots before and after light ageing.

FIG. 10 shows a table (i.e., Table 1) illustrating the photostability of CuInS₂/ZnS and CuInS₂/ZnS:Al laminated films with Al-doping at different temperature and reaction intervals.

FIG. 11 is a table (i.e., Table 2) showing the chemical composition of CuInS₂/ZnS, CuInS₂/ZnS:Al, and CuInS₂/ZnS:Al/Al₂O₃ quantum dots.

### DEFINITIONS AND ABBREVIATIONS

The following explanations of terms and abbreviations are provided to better describe the present disclosure and to guide those of ordinary skill in the art in the practice of systems, methodologies and compositions disclosed herein.

As used herein, “comprising” means “including,” and the singular form “a” or “an” or “the” include plural references unless the context clearly indicates otherwise. Unless the context clearly indicates otherwise, the term “or” is inclusive, and thus refers to both a single element of stated alternative elements and a combination of two or more of those elements.

Unless explained otherwise, all technical and scientific terms used herein have the same meaning as commonly understood to one or ordinary skill in the art to which this disclosure relates. Suitable methods and compositions are described herein for the practice or testing of the systems, methodologies and compositions described herein. However, it is to be understood that other methods and materials similar, or equivalent to, those described herein may be used in the practice or testing of these systems, methodologies and compositions disclosed herein. Consequently, the systems, methodologies, compositions, and examples disclosed herein are illustrative only, and are not intended to be limiting. Other features of the present disclosure will be apparent to those skilled in the art from the following detailed description and the appended claims.

Unless otherwise indicated, all numbers expressing quantities of components, percentages, temperatures, times, and so forth as used in the specification or claims are to be understood as being modified by the term “about.” Unless otherwise indicated, non-numerical properties such as colloidal, continuous, crystalline, and so forth as used in the specification or claims are to be understood as being modified by the term “substantially,” meaning to a great extent or degree. Accordingly, unless otherwise indicated implicitly or explicitly, the numerical parameter and/or non-numerical properties set forth herein are approximations, and the optimal values of these properties and parameters may depend on the desired properties sought, the limits of detection under standard test conditions or methods, the limitations of the processing methods, and/or the nature of the property or parameter. When directly and explicitly distinguishing embodiments from disclosed prior art, the embodiment numbers are not approximations unless the word “about” is recited.

Colloidal suspension: A mixture consisting of a disperse phase (the suspended particles) and a continuous phase (the liquid medium of suspension), wherein the mixture either does not settle, or would take a very long time to settle appreciably.

Dispersibility: The ability of quantum dots (QDs) to form a colloidal suspension.

Emission spectrum: Those portions of the electromagnetic spectrum over which QDs (or a composition containing them) exhibit photoluminescence (in response to excitation by a light source) whose amplitude is at least 1% of the peak photoluminescence emission.

Fluorophore: A material which absorbs a first spectrum of light and emits a second spectrum of light, such materials often referred to as being fluorescent or luminescent.

Ligands: Quantum dots (QDs) usually include surface-passivating (capping) ligands, often organic ligands. Such ligands are commonly introduced during synthesis and can include tri-n-octylphosphine oxide (TOPO), tri-n-octylphosphine (TOP), 1-dodecanethiol (DDT), oleylamine (OA) or oleic acid/oleate. These are large ligands containing from 8 to 24 carbon atoms and may inhibit binding of the quantum dots to a substrate of a linker. Thus, in some embodiments, the quantum dots are capped or re-capped with a smaller ligand, e.g., a ligand including only 10 or fewer carbon atoms such as pyridine, or an amine such as aryl or lower alkyl amines. Such ligands may have a chemical formula of RNH₂ where R is a lower alkyl, such as a C2 to C4 alkyl. Suitable amines include but are not limited to, allylamine, propylamine, butylamine (e.g., n-butylamine or t-butylamine), pentylamine, hexylamine, heptylamine, octylamine, aniline, and benzylamine. A recent patent, i.e., U.S. Pat. No. 11,370,966, describes a large number of suitable ligands, hereby incorporated by reference.

Nanoparticle: A nanoscale particle of a solid material. The nanoparticles disclosed herein are preferably crystalline and have a size of less than 100 nanometers in dimension. The nanoparticles disclosed herein may form a colloidal suspension. Embodiments of the disclosed nanoparticles may be of a single material or blends of single materials or may include an inner core and an outer shell of differing blends of materials. The nanoparticles may further include a plurality of ligands bound to the nanoparticle outer surface. Exemplary nanoparticles which may be utilized in the compositions, systems and methodologies described herein generally comprise metal chalcogenides or semiconductors.

Photoluminescence (PL): The emission of light (electromagnetic radiation, in the form of photons) after the absorption of light. It is one form of luminescence (light emission) and is initiated by photoexcitation (excitation by photons).

Photostability: Where quantum dots are less subject to photodegradation such that their quantum yield remains largely stable and intact and there is not an appreciable decrease in photoluminescence.

Polymers: A large molecule, or macromolecule, composed of many repeating subunits. Polymers range from familiar synthetic plastics such as polystyrene or poly(methyl methacrylate) (PMMA). Polymers are created via polymerization of many smaller molecules, e.g., monomers. Exemplary polymers useful in the present invention include polymers of ethylene vinyl acetate, ethylene vinyl alcohol, polyethylene, acrylate, poly vinyl alcohol, polyvinyl acetate, and polyurethane, polyvinyl butyral, polyvinyl pyrrolidone and the like.

Quantum Dots: A nanoparticle that exhibits size dependent electronic and optical properties due to quantum confinement. The quantum dots disclosed herein preferably have at least one dimension less than about 50 nanometers. The disclosed quantum dots may be colloidal quantum dots. Some of the quantum dots which may be utilized in the compositions, systems and methodologies described herein are ternary, quaternary, and/or alloyed quantum dots including, but not limited to, ZnSSe, ZnSeTe, ZnSTe, CdSSe, CdSeTe, HgSSe, HgSeTe, HgSTe, ZnCdS, ZnCdSe, ZnCdTe, ZnHgS, ZnHgSe, ZnHgTe, CdHgS, CdHgSe, CdHgTe, ZnCdSSe, ZnCdSeTe, ZnHgSeTe, ZnHgSSe, CdHgSSe, CdHgSeTe, CuAlS₂, CuAlSe₂, CuFeSe₂, CuFeS₂, CuInS₂, CuInSe₂, CuInGaSe₂, CuInZnS₂, CuZnSnSe₂, CuIn(Se,S)₂, CuInZn(Se,S)₂, AgInS₂, AgInSe₂, and AgIn(Se,S)₂ quantum dots. Embodiments of the disclosed quantum dots may be of a single material or may include an inner core and an outer shell of differing materials. The outer shell may be a thin shell or thick layer. The quantum dots may further include a plurality of ligands bound to the quantum dot surface. Where the present quantum dots are shown as, e.g., M₁M₂(Se,S)₂ or M₁M₂M₃(Se,S)₂ (M₁, M₂ and M₃ each representing a metal such as Cu, In, Zn and the like), Se and S as shown should be understand as being present in a combined amount of 2, i.e., each is there in amounts from 0 to 2 with the combined total being equal to 2. Another way of showing this is, e.g., CuInSeₓS₂₋ₓ where x is from 0 to 2, such that when x is 0, the material is CuInS₂ and when x is 2 the material is CuInSe₂.

Solubility: When used in reference to quantum dots, the ability of quantum dots to form a clear colloidal suspension without haze caused by formation of aggregates.

### DETAILED DESCRIPTION OF VARIOUS EMBODIMENTS

The present invention is directed to nanoparticle or quantum dot formulations having improved photostability. In one approach such improved photostability results from addition of a metal dopant to the nanoparticle or quantum dot formulation. This improved photostability is in comparison to similar structured nanoparticle or quantum dot formulations without the metal dopant. In another approach such improved photostability results from a metal oxide coating on the outside of the nanoparticle or quantum dot formulation. As with the metal dopant, such improved photostability is in comparison to similar structured nanoparticle or quantum dot formulations without the metal oxide coating.

The photostability of the present compositions allow for their uses in their common applications such as LEDs, displays, greenhouse films, security inks and the like.

The dopant metals used in the present invention can aid in prolonging the photostability of the quantum dots especially in comparison to similar quantum dots without the dopant metals. Suitable dopant metals may include aluminum, silicon, tin, cerium, titanium, tungsten, or molybdenum. Aluminum is a preferred dopant metal.

The amount of a dopant metal is generally present in an amount from about 0.1 to about 10 percent by weight relative to the other elements, more usually from about 4 to about 8 percent by weight. It may be found that there a gradient of the dopant metal in the quantum dot with higher levels nearer the outside of the dot and lesser amounts towards the center of the dot. It may also be found that there a gradient of the dopant metal in the quantum dot is uniform across the depth of the dot. While not expected, it may also be found that the gradient of the dopant metal has higher amounts near the center of the dot.

The core-shell quantum dots can further include mercapto silane ligands or amino silane ligands as capping ligands or capping agents upon the outer surface of the shell layer. These ligands are multifunctional such that they can build molecular bridges between the quantum dot and a subsequent layer of, e.g., a metal oxide layer. The mercapto group of these ligands serves to bind to the outside of the quantum dot, i.e., the outer shell. Among the suitable mercapto silane ligands or amino silane ligands may be (3-mercaptopropyl) trimethoxysilane (MPTMS), (3-mercaptopropyl) triethoxysilane (MPTES), (3-mercaptopropyl) methyl dimethoxysilane (MPMDMS), (3-mercaptopropyl) methyl diethoxysilane (MPMDES), (3- mercaptomethyl) trimethoxysilane (MMTMS), (3- mercaptomethyl) triethoxysilane (MMTES), (3- aminopropyl) dimethylmethoxysilane (APDMMS), (3- aminopropyl) triethoxysilane (APTES), and (3- aminopropyl) trimethoxysilane (APTMS). Among more preferred mercapto silane ligands are included (3-mercaptopropyl) trimethoxy silane (MPTMS), and (3- mercaptopropyl) triethoxysilane (MPTES). A preferred mercapto ligand is (3- mercaptopropyl) trimethoxysilane (MPTMS).

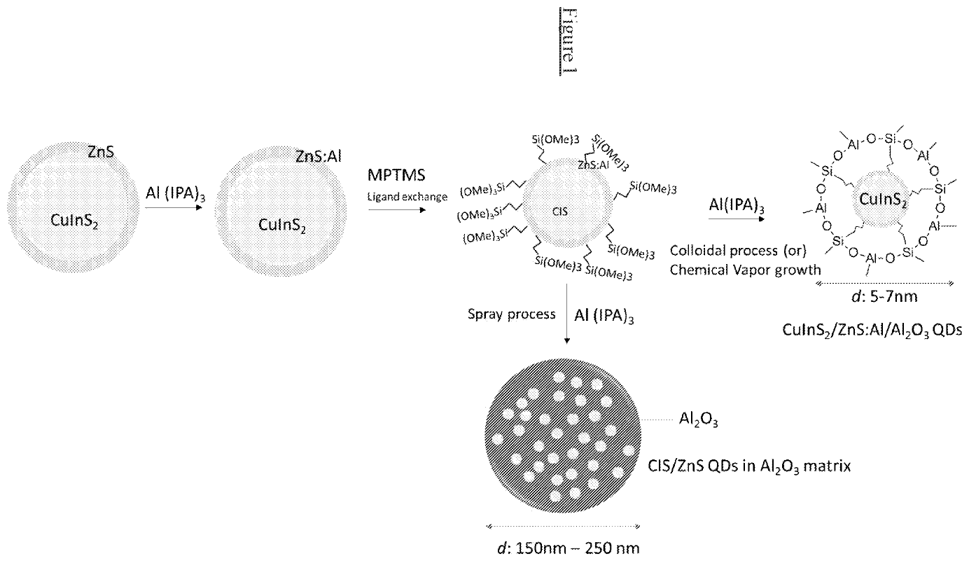

In FIG. 1 is shown, the schematic synthesis of CuInS₂/ZnS:Al, CuInS₂/ZnS:Al/Al₂O₃, and CuInS₂/ZnS:Al in Al₂O₃ matrix by colloidal, chemical vapor growth or spray pyrolysis methods. From left to right, an initial CuInS₂/ZnS quantum dot can receive doping of aluminum onto the surface and sometimes into the depth of the quantum dot in a gradient of concentrations as represented by the addition of Al(IPA)₃. Subsequently, ligand exchange can be carried out as shown here by the MPTMS to obtain the ligand surrounded quantum dot. Continuing from left to right, a colloidal process or chemical vapor growth process can be used with additional Al(IPA)₃ to achieve the CuInS₂/ZnS:Al/Al₂O₃. Alternatively, the spray process is shown, also using Al(IPA)₃ to obtain the CuInS₂/ZnS:Al in Al₂O₃ matrix.

### EXAMPLES

The following examples are non-limiting and are merely intended to further illustrate the compositions, systems and methodologies described herein.

### Example 1

In a typical synthesis, CuInS₂ cores were pre-synthesized in accordance with the procedure in Li et al., Efficient Synthesis of Highly Luminescent Copper Indium Sulfide-Based Core/Shell Nanocrystals with Surprisingly Long-Lived Emission. J. Am. Chem. Soc. 2011, 133, 1176-1179, and dissolved in octadecene to form a solution. The same or similar process can be used to make CuAlS₂, CuAlSe₂, CuFeSe₂, CuFeSe₂, A solution of zinc oleate (19.8 g, 1 M) and octadecene (20 ml) was prepared in a 250 ml round bottom flask by heating zinc oleate at 80° C. The solution was degassed under vacuum for 30 minutes to remove moisture and oxygen. Cores of CuInS₂ in octadecene (6 ml) and 1-dodecanethiol (5 ml) were added to the flask under constant stirring and degassed further for 1 hour. Finally, the flask was heated to 250° C. under nitrogen for 6 hours to result in formation of a ZnS shell around the cores. The solution was then allowed to cool following the 6 hours.

In a separate flask fitted with a bump trap adaptor, aluminum isopropoxide (3 g) was dissolved in dodecanethiol (5 ml) at 60° C. until clear/transparent (or degassed at 80° C. for one hour. The nanocrystalline particles of the CuInS₂ cores with the ZnS shells were added to the clear/transparent solution and degassed for 1 hour. Finally, the flask was heated at 250° C. for 4 hours to obtain aluminum doping of the ZnS shell. At the end of this period, the reaction mixture of a slightly viscous orange liquid was obtained after cooling. The quantum dots were then precipitated with ethanol and washed with chloroform multiple times (2-4 times) whereby a chunky powder was obtained. This was dried under vacuum overnight for about 12 hours to obtain a resultant powder of aluminum doped CuInS₂/ZnS quantum dots.

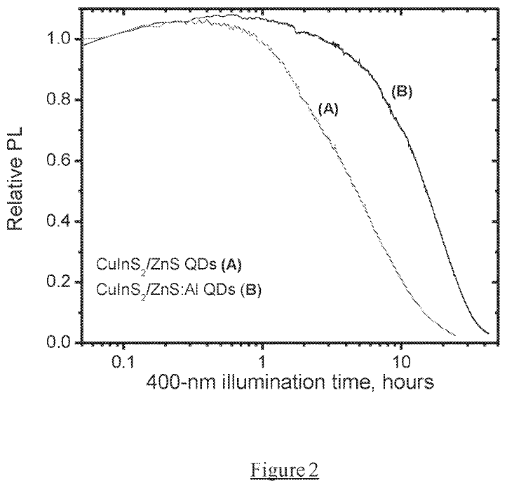

FIG. 2 shows the photostability of the aluminum doped CuInS₂/ZnS quantum dots in comparison to undoped CuInS₂/ZnS quantum dots and the maintained levels of photoluminescence during long periods of 400 nm light illumination time at 50° C. can be seen.

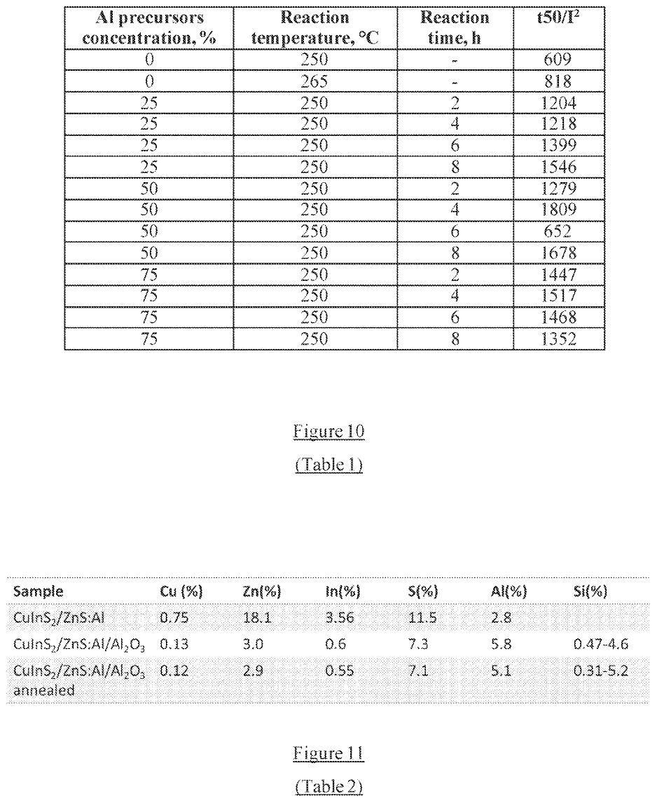

In Table 1 (see FIG. 10), the photostability of films prepared using undoped and Al-doped CuInS₂/ZnS quantum dots prepared at different temperature and reaction times is shown. The increase in photostability with the addition of the aluminum dopant is consistently seen in nearly all samples.

### Example 2

Quantum dots, isolated from Example 1, were added to a 3-neck 100 ml round bottom flask fitted with a condenser along with octadecane to form an initial mixture. To that mixture was added a ligand of (3-mercaptopropyl)trimethoxysilane to the flask and the mixture was stirred at 120° C. for 3 hours under nitrogen. The quantum dots were precipitated from the mixture by addition of acetone and then re-dispersed in chloroform followed by precipitation with acetone for 2 more times.

### Example 3

Quantum dots, isolated from Example 1, were added to a 3-neck 100 ml round bottom flask fitted with a condenser along with octadecane to form an initial mixture. To that mixture was added a ligand of (3-mercaptopropyl)-methyl dimethoxysilane to the flask and the mixture was stirred at 120° C. for 3 hours under nitrogen. The quantum dots were precipitated from the mixture by addition of acetone and then re-dispersed in chloroform followed by precipitation with acetone for 2 more times.

### Example 4

Quantum dots, isolated from Example 1, were added to a 3-neck 100 ml round bottom flask fitted with a condenser along with octadecane to form an initial mixture. To that mixture was added a ligand of (3-mercaptopropyl)-methyl diethoxysilane to the flask and the mixture was stirred at 120° C. for 3 hours under nitrogen. The quantum dots were precipitated from the mixture by addition of acetone and then re-dispersed in chloroform followed by precipitation with acetone for 2 more times.

### Example 5

Quantum dots, isolated from Example 1, were added to a 3-neck 100 ml round bottom flask fitted with a condenser along with octadecane to form an initial mixture. To that mixture was added a ligand of (3-mercaptopropyl)-triethoxysilane to the flask and the mixture was stirred at 120° C. for 3 hours under nitrogen. The quantum dots were precipitated from the mixture by addition of acetone and then re-dispersed in chloroform followed by precipitation with acetone for 2 more times.

### Example 6

Quantum dots, isolated from Example 1, were added to a 3-neck 100 ml round bottom flask fitted with a condenser along with octadecane to form an initial mixture. To that mixture was added a ligand of (3-aminopropyl)-trimethoxysilane to the flask and the mixture was stirred at 120° C. for 3 hours under nitrogen. The quantum dots were precipitated from the mixture by addition of acetone and then re-dispersed in chloroform followed by precipitation with acetone for 2 more times.

### Example 7

Quantum dots, isolated from Example 1, were added to a 3-neck 100 ml round bottom flask fitted with a condenser along with octadecane to form an initial mixture. To that mixture was added a ligand of (3-aminopropyl)-methyl dimethoxysilane to the flask and the mixture was stirred at 120° C. for 3 hours under nitrogen. The quantum dots were precipitated from the mixture by addition of acetone and then re-dispersed in chloroform followed by precipitation with acetone for 2 more times.

### Example 8

Aluminum isopropoxide (3 g) was dissolved in 1-dodecane-thiol (5 ml) until it forms a clear solution.

Ligand-exchanged quantum dots, isolated from Examples 2-7, were added to a 3-neck 100 ml round bottom flask. To that mixture was added the solution of aluminum isopropoxide into the flask and the mixture was stirred at 120° C. for 3 hours under nitrogen. The quantum dots were precipitated from the mixture by addition of acetone and then re-dispersed in chloroform, followed by precipitation with acetone for 2 more times.

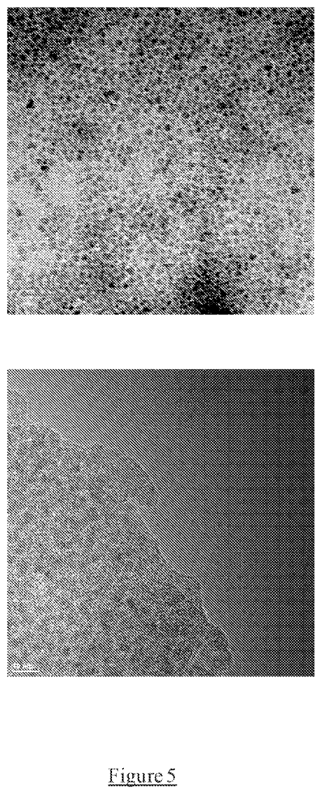

FIG. 1 shows the schematic view of QDs obtained by this process. FIG. 5 shows the TEM images of the particles obtained by this process. Table 2 (FIG. 11) shows chemical composition of the particles obtained by this process measured using ICP-OES indicating the presence of Si and Al in CuInS₂/ZnS:Al/Al₂O₃ particles.

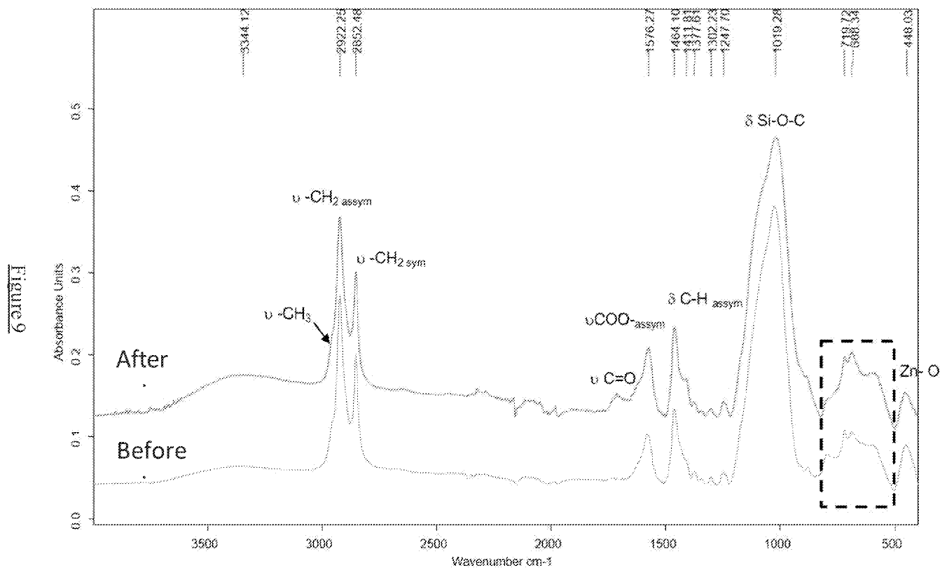

FIG. 9 shows FT-IR spectra of CuIns 2/ZnS: Al/Al₂O₃ powders before and after photo illumination indicating no chemical change.

### Example 9

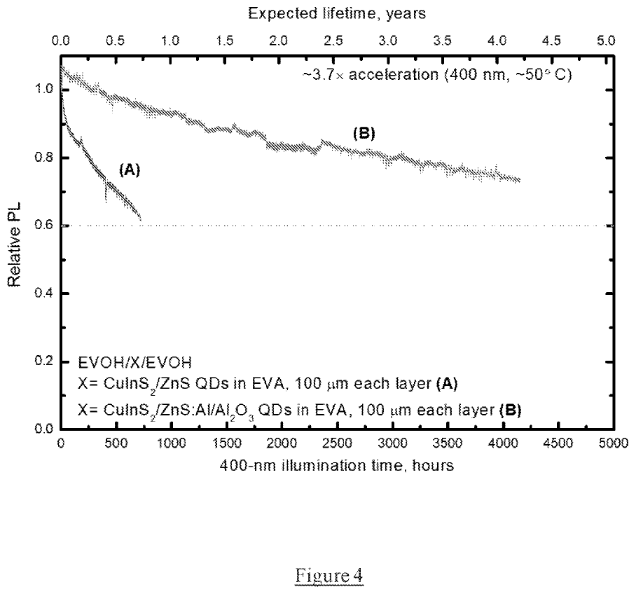

This example shows fabrication of ethylene vinyl acetate films with 4% (w/w) CuInS₂/ZnS:Al nanocrystals from Example 2 overcoated with aluminum oxide as in Example 8. Ethylene vinyl acetate pellets 96 % (w/w) and CuInS₂/ZnS:Al/MPTMS/Al₂O₃ particles (nanocrystals) were introduced into an extruder through a hopper and extruded at 150° C. at 50 rpm to form a polymer string. This polymer string was pelletized with a pelletizer (a Thermofisher VeriCut Pelletizer). The resultant extruded pellets were hot pressed to form a single layer film. The results of examination of this film are shown in FIG. 4 where the increase in photostability with the addition of the aluminum dopant is seen.

### Example 10

This example shows fabrication of ethylene vinyl alcohol films with CuInS₂/ZnS:Al nanocrystals from Example 2 overcoated with aluminum oxide as in Example 8. Ethylene vinyl alcohol pellets 96 % (w/w) and 4% (w/w) CuInS₂/ZnS:Al/MPTMS/Al₂O₃ particles (nanocrystals) were introduced into the extruder through a hopper and extruded at 200° C. at 50 rpm to form a polymer string. This polymer string was pelletized with the pelletizer. The resultant extruded pellets were hot pressed to form a single layer film.

### Example 11

This example shows fabrication of polyethylene films with CuInS₂/ZnS:Al nanocrystals from Example 2 overcoated with aluminum oxide as in Example 8. Polyethylene pellets 96 % (w/w) and 4% (w/w) CuInS₂/ZnS:Al/MPTMS/Al₂O₃ particles (nanocrystals) were introduced into the extruder through a hopper and extruded at 170° C. at 50 rpm to form a polymer string. This polymer string was pelletized with the pelletizer. The resultant extruded pellets were hot pressed to form a single layer film.

### Example 12

This example shows fabrication of acrylate films with CuInS₂/ZnS:Al nanocrystals from Example 2 overcoated with aluminum oxide as in Example 8. Thermoset acrylate pellets 96 % (w/w) and 4% (w/w) CuInS₂/ZnS:Al/MPTMS/Al₂O₃ particles (nanocrystals) were mixed together and coated between two sheets of polyethylene terephlate by photocuring using 320 nm light.

### Example 13

This example shows fabrication of acrylate films with CuInS₂/ZnS:Al nanocrystals from Example 2 overcoated with aluminum oxide as in Example 8. Thermoset acrylate pellets 96 % (w/w) and 4% (w/w) CuInS₂/ZnS:Al/MPTMS/Al₂O₃ particles (nanocrystals) were mixed together and coated between two sheets of polyethylene terephthalate (PET) by thermal curing at 80° C.

### Example 14

Films for photostability: Drawdown: Photostability of the Al-doped CIS/ZnS dots were tested by adding the as quantum dots obtained from examples 1-13 above dissolved in octadecene to an acrylic resin. This was placed between two pieces of polycarbonate films and cured with 400 nm UV light to make a 100 μm composite film. The T50 was recorded as the time (in hours) required by the QDs to reach half the initial photoluminescence (PL) and the plots are shown in FIG. 2.

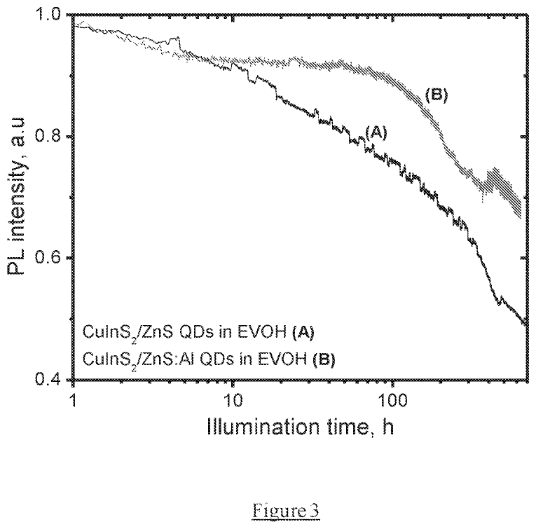

Pressed films: The quantum dot-polymer blends from each of examples 9-11 were extruded from a twin-screw extruder and pressed into 100 μm thick films. The T50 was recorded as the time (in hours) required by the QDs to reach half the initial photoluminescence (PL) as shown FIGS. 3 and 4. It was observed that the T50 value had a strong dependence on the thickness of the interlayer resin.

### Example 15

The quantum dots obtained by Example 1 were washed via precipitation and re-suspension as in that example to obtain quantum dot powder (Aluminum-incorporated quantum dots), mixed with a quantity of ethylene vinyl acetate (EVA) and separately with a quantity of ethylene vinyl alcohol (EVOH) pellets.

In a first run, the aluminum-doped quantum dot powder was mixed with ethylene vinyl acetate (EVA) at a 2% loading by weight and extruded using a twin-screw extruder at 150° C. and 50 RPM. The extruded samples were pressed into thin films at 150° C. into 100 μm films and tested for photostability.

In a second run, the aluminum-doped quantum dot powder was mixed with ethylene vinyl alcohol (EVOH) at 2% loading by weight and extruded using a twin-screw extruder at 150° C. and 50 RPM. The extruded samples were pressed into thin films at 170° C. into 100 μm films and tested for photostability with results as shown in FIG. 3. It was observed that the aluminum-doped samples had significantly lower haze (indicating better dispersion in the polymer film) when compared to a similar quantum dot sample without the aluminum doping.

### Example 16

Aluminum doped quantum dots with an aluminum oxide shell (shown in FIG. 1) were prepared as follows via colloidal synthesis. MPTMS ligand exchanged dots were dispersed in octadecene through sonication for 20 minutes. In a round bottom flask, aluminum isopropoxide and octadecene were heated and degassed at 80° C. for 20 minutes. A transparent liquid was obtained. The MPTMS ligand exchanged QDs were added under nitrogen and the whole mixture was further degassed for 40 minutes (a total of 1 to 1.5 hours). The reaction was then kept under nitrogen and heated up to 250° C. whereupon the reaction turned from a liquid mixture to a solid powder after 2.5 hours. The reaction was cooled down, and the quantum dots were washed with chloroform and acetone several times to remove unreacted precursors. The powder was annealed at 200° C. under vacuum to remove high-boiling solvents. The quantum dot powder was extruded with ethylene vinyl acetate to make highly stable nanocomposite films.

### Example 17

Optimization of the synthetic conditions of Al-doped dots showed that Al-doped dots heated for 4 hours at 250° C. showed the highest stability, with a T50 three times higher than the control standard quantum dots (no aluminum doping) in polycarbonate films.

### Example 18

Extruded films containing a plurality of quantum dots, silane ligands, and aluminum oxide may maintain 80% of their initial photoluminescence after exposure to sunlight after one year in a greenhouse environment. These films may thus boost crop yield by optimizing the spectrum of sunlight.

### Example 19

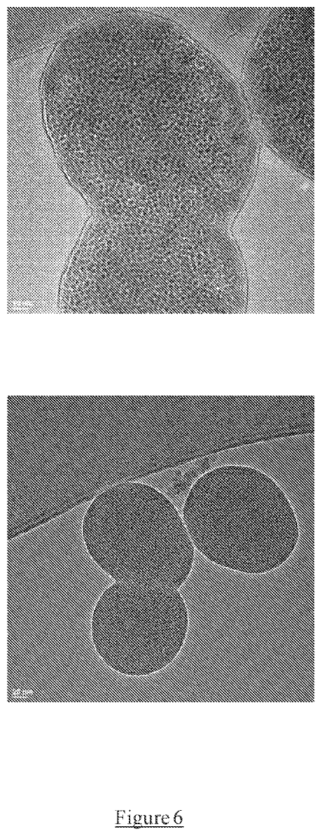

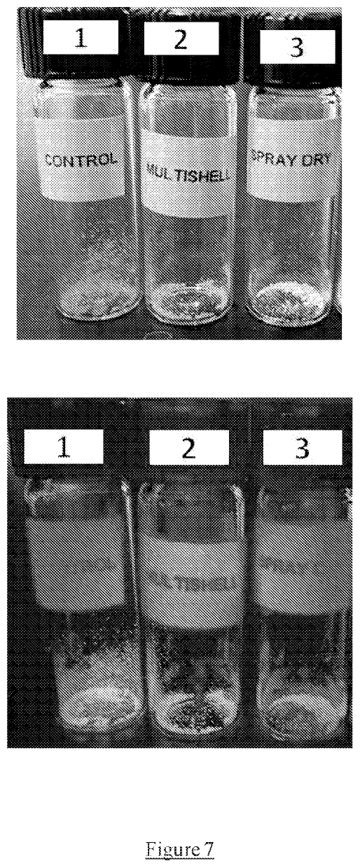

Ligand-exchanged quantum dots, isolated from Examples 2-7, were dissolved in 15 mL of toluene or 1-octadecene and added to a 3-neck 100 ml round bottom flask along with 5 g of aluminum isopropoxide and connected to a quartz tube using a flexible hose and another end of the quartz tube was connected to a 3-neck round bottom flask collection vessel. The quartz tube was placed on the tube furnace in a vertical configuration. The quantum dots solution was aerosolized using an ultrasonic mist generator. The aerosols from the quantum solution were passed though the tube furnace using the nitrogen carrier gas and the resulting Al₂O₃ coated quantum dots were collected in the collection vessel. FIG. 1 shows the schematic view of QDs obtained by this process. FIG. 6 shows the TEM images of the particles obtained by this process. FIG. 7 shows picture of vials containing powders of CuInS₂/ZnS, CuInS₂/ZnS:Al/Al₂O₃ and CuInS₂/ZnS:Al quantum dots (QDs) in Al₂O₃ matrix in ambient and UV-light.

### Example 20

Ligand-exchanged quantum dots, isolated from Examples 2-7, were each added to a respective 3-neck 100 ml round bottom flask. In another 3-neck round bottom flask, 5 g of aluminum isopropoxide was heated to 120° C. and connected to each quantum dot flask and the aluminum isopropoxide vapor was transferred to the quantum dots flask using the nitrogen carrier gas for from 2 to 6 hours. The resulting Al₂O₃ coated quantum dots were precipitated from the mixture by addition of acetone and then re-dispersed in chloroform, followed by precipitation with acetone for 2 more times. FIG. 1 shows a schematic view of the QDs obtained by this process.

### Example 21

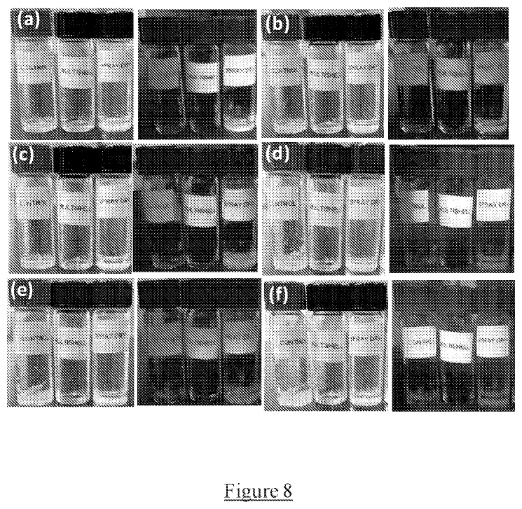

To test the chemical stability, powders of CuIns₂/ZnS, CuIns₂/ZnS:Al/Al₂O₃ and CuIns₂/ZnS:Al quantum dots (QDs) in Al₂O₃ matrix were mixed with concentrated HNO₃ and the photoluminescence emission was monitored periodically from 5 to 120 minutes by illuminating with UV light. FIG. 8 shows picture of vials in ambient and UV-light demonstrating the chemical stability of CuInS₂/ZnS:Al quantum dots (QDs) in Al₂O₃ matrix obtained by the spray pyrolysis process explained in example 19.

### Example 22

This example shows fabrication of ethylene vinyl alcohol films with CuInS₂/ZnS:Al quantum dots from Example 1. Ethylene vinyl alcohol pellets 96% (w/w) and 4% (w/w) CuInS₂/ZnS:Al quantum dots were introduced into the extruder through a hopper and extruded at 200° C. at 50 rpm to form a polymer string. This polymer string was pelletized with a pelletizer. The resultant extruded pellets were hot pressed to form a single layer film. The examination of this film yielded the results shown in FIG. 3 where the addition of aluminum dopant showed an increase in photostability in comparison to a film with undoped CuInS₂/ZnS quantum dots.

### CONCLUSION

Although the present invention has been described with reference to specific details, it is not intended that such details should be regarded as limitations upon the scope of the invention. Various modifications, substitutions, combinations, and ranges of parameters may be made or utilized in the compositions, and methodologies described herein.

What is claimed is:

1. A composition comprising:
a plurality of fluorophore particles, each comprised of at least one semiconductor nanoparticle core and at least one semiconductor shell at least partially surrounding the core, wherein at least one atomic layer of the fluorophore particles includes aluminum atoms.

2. The composition of claim 1 further comprising silane ligands at the nanoparticle surface.

3. The composition of claim 2, wherein the ligand is selected from the group consisting of mercaptosilanes and aminosilanes.

4. The composition of claim 2, wherein the ligand is selected from the group consisting of (3-mercaptopropyl)trimethoxy silane, (3-mercaptopropyl)triethoxysilane, 3-mercaptopropylmethyldimethoxysilane, 3-mercaptomethlytrimethoxysilane, 3-mercaptomethyltriethoxysilane, (3-aminopropyl)dimethylmethoxysilane, (3-aminopropyl)triethoxysilane, and (3-aminopropyl)trimethoxysilane.

5. The composition of claim 1, wherein the fluorophore particles are further encapsulated with a metal oxide layer.

6. The composition of claim 5, wherein the metal oxide layer is selected from the group consisting of aluminum oxide, aluminum silicate, and silicon oxide.

7. The composition of claim 1, wherein said semiconductor nanoparticles comprise a material selected from the group consisting of CuAlS₂, CuAlSe₂, CuFeSe₂, CuFeSe₂, CuInS₂, CuInSe₂, CuInGaSe₂, CuInZnS₂, CuZnSnSe₂, CuIn(Se,S)₂, CuInZn(Se,S)₂, AgInS₂, AgInSe₂, and AgIn(Se,S)₂.

8. The composition of claim 1, wherein the semiconductor shell material is selected from the group consisting of ZnS and ZnSe.

9. The composition of claim 1, wherein the shell of the fluorophore particles has an aluminum concentration gradient increasing from nearer the core to further from the core.

10. The composition of claim 1, wherein the shell of the fluorophore particles has an aluminum concentration gradient increasing from further from the core to nearer to the core.

11. An optical medium comprising:
a polymer matrix; and
a plurality of fluorophore particles, each comprised of at least one semiconductor nanoparticle core and at least one semiconductor shell at least partially surrounding the core,
wherein at least one atomic layer of the fluorophore particles includes aluminum atoms, the surface of the shell is capped with silane ligands, and wherein the fluorophore particles are further at least partially overcoated upon the shell with a metal oxide layer.

12. The optical medium of claim 11, wherein said semiconductor nanoparticles comprise a material selected from the group consisting of CuAlS₂, CuAlSe₂, CuFeSe₂, CuFeSe₂, CuInS₂, CuInSe₂, CuInGaSe₂, CuInZnS₂, CuZnSnSe₂, CuIn(Se,S)₂, CuInZn(Se,S)₂, AgInS₂, AgInSe₂, and AgIn(Se,S)₂.

13. The optical medium of claim 11, wherein said semiconductor nanoparticles comprise a material selected from the group consisting of CuAlS₂, CuAlSe₂, CuFeSe₂, CuFeSe₂, CuInS₂, CuInSe₂, CuInGaSe₂, CuInZnS₂, CuZnSnSe₂, CuIn(Se,S)₂, CuInZn(Se,S)₂, AgInS₂, AgInSe₂, and AgIn(Se,S)₂.

14. The optical medium of claim 11, wherein the semiconductor shell material is selected from the group consisting of ZnS and ZnSe.

15. The optical medium of claim 11, wherein the shell of the fluorophore particles has an aluminum concentration gradient increasing from nearer the core to further from the core.

16. The optical medium of claim 11, wherein the shell of the fluorophore particles has an aluminum concentration gradient increasing from further from the core to nearer to the core.

17. The optical medium of claim 11, wherein the ligand is selected from the group consisting of mercaptosilanes and aminosilanes.

18. The optical medium of claim 11, wherein the ligand is selected from the group consisting of (3-mercaptopropyl)trimethoxysilane, (3-mercaptopropyl)triethoxysilane, 3-mercaptopropylmethyldimethoxysilane, 3-mercaptomethlytrimethoxysilane, 3-mercaptomethyltriethoxy silane, (3-aminopropyl)dimethylmethoxysilane, (3-aminopropyl)triethoxysilane, and (3-aminopropyl)trimethoxysilane.

19. The optical medium of claim 11, wherein the metal oxide layer is selected from the group consisting of aluminum oxide, aluminum silicate, and silicon oxide.

20. An optical medium comprising:
a polymer matrix containing a plurality of quantum dots, silane ligands, and aluminum oxide that maintains at least 80% of its initial photoluminescence after exposure to sunlight for one year.
